(19) United States
(12) Patent Application Publication
(10) Pub. No.: US 2016/0088085 A1
(43) Pub. Date: Mar. 24, 2016

(54) METHOD FOR DATA INTERCHANGE IN A COMPUTER NETWORK (VARIANTS)

(71) Applicant: Yury Vitalevich MISOLIN, MIRA (RU)

(72) Inventor: Yury Vitalevich MISOLIN, MIRA (RU)

(21) Appl. No.: 14/696,002

(22) Filed: Apr. 24, 2015

Related U.S. Application Data
(63) Continuation of application No. 13/703,748, filed on Dec. 12, 2012.

(51) Int. Cl. H04L 29/08

(52) U.S. Cl. CPC H04L 67/1097; H04L 67/306

(57) ABSTRACT

A method including the steps of sending from, users computer devices, a request to a remote server for transfer and movement of an object from a starting point to a destination point, stating the locations of the points; limiting the range and transfer time for the position of the object. The remote server selects from a database, data relating to the locations of the computer users performing the transfer. The remote server transmits, over the Internet, a record of the locations of the computer user's performing the transfer and located within said limitation of the range for the position of object, the status, the type of vehicle and data relating to means for communicating with the computer user's performing the transfer.

### CROSS REFERENCE TO RELATED APPLICATION

This application claims benefit under 35 U.S.C. §371 to international application No. PCT/RU2010/000324, filed on Jun. 15, 2010, the contents of which are incorporated by reference herein in its entirety.

### FIELD OF THE INVENTION

This invention relates to computer field and may be used in technologies of information retrieval and communications between computer users via the Internet.

### PRIOR ART

A method for organizing a social network is known, wherein computing devices, for example, subscriber computers, transfer data on them to a website where they are logged in to, each computing device creating a user profile including information on the subscriber and being linked to his identifier. Subscriber identifiers associated with subscriber devices logged in to the website are monitored. The website defines a real (virtual) space, and the logged-in subscriber devices are characterized as present in the real (virtual) space. A web page is served to the computing devices of the present subscribers via the network. The web page of an existing subscriber comprises a subscriber icon associated with the existing subscriber and subscriber icons of other present subscribers. A determination is made whether the existing subscriber profile snatches the subscriber profile of one or more of the other present subscribers according to matching criteria. An attribute is assigned to the icons of the other present subscribers that match the profile of the existing subscriber according to matching criteria. Selected profile information is provided to the existing subscriber of a selected one of any of the other present matching subscribers via the associated icon (U.S. Pat. No. 7,522,058).

According to this method, a social network is organized by means of communicating computing devices of various subscribers (primarily, via the Internet), with due regard to intentions of subscribers themselves.

This technical solution is limited in that constructing a social network subject to subscriber intentions only does not enable quickly process a huge data array on them, and the system used for realizing this method requires use of a very powerful server.

Another computer implemented method of constructing a social network is also known, the method including constructing the social network from a plurality of disparate, heterogenous data sources, wherein at least one of the plurality of disparate, heterogenous data sources includes a user generated data source; identifying a plurality of nodes and linkages; determining attributes of the nodes and linkages based on a plurality of disparate, heterogenous data sources, wherein the plurality of disparate, heterogenous data sources includes a combination of the user generated data source and at least one non-user generated source, wherein the attributes include at least one of a deterministic attribute, a probabilistic attribute, and a dynamic attribute; populating a mathematical decision-making model based on the plurality of nodes and linkages, and the determined attributes of the plurality of nodes and linkages; determining attributes of the nodes and links at a second point in time; re-populating the mathematical decision-making model based on the plurality of nodes and linkages, and the determined attributes of the plurality of nodes and linkages at the second point in time. A user generated data source includes at least one survey data source, analyzing and diagnosing collaboration barriers and risks in-between a plurality of nodes in a social network. The attributes for determining nodes and linkages at a second point of time include collecting data from a plurality of disparate, heterogeneous data sources, and such a plurality of disparate, heterogeneous data sources includes at least one of survey data, social computing data, and combinations thereof. (U.S. Pat. No. 7,512,628).

The method is rather complicated and may not ensure sufficiently quick communication between computing device users.

An Internet based method for facilitating networking among persons with similar interests is also known. (U.S. Pat. No. 6,745,178).

This method comprises the following steps: accepting a fist query statement from a first user; storing a first item of information related to the first query; accepting a second query for a second user; storing a second item of information related to the second query; computing a measure of similarity of the first query and the second query by using the first item of information and the second item of information, generating a list of answers in a union of the first item of information and the second item of information; generating a set of score difference terms for each answer in the list; forming a sum by summing the set of score difference terms; comparing the measure of similarity to a threshold similarity criterion; in the case that the measure of similarity meets the threshold similarity criterion, informing the first user of the second user; accepting a request from the first user to invite the second user to participate in a chat session; forwarding the request to the second user; accepting an agreement from the second user to chat; and establishing a chat session between the first user and the second user.

A limitation of this method is its low functional capacities and a rather long time for determining people with similar interests.

Electronic interactive maps are also known that enable a user to select a point of departure and a point of destination and constructs a route from the point of departure to the point of destination, with due regard to the travel direction along the city streets and the existing traffic interchanges. (http:/www.moscowmap.ru), (http://maps.yandex.ru).

This method for determining a travel route by means of electronic interactive maps enables to determine a route total length and medium time, traffic jams or show a return route from the point of destination to the point of departure.

A limitation of this method is impossibility of transporting by other persons or various types of vehicles without finding a carrier first. If a car owner finds an optimized route by means of electronic interactive maps, then he usually follows the found route in a natural way.

### SUMMARY OF THE INVENTION

The present invention is based on the task of creating a method for data interchange in a computer network, which enables to speed-up the data processing and expand functional capabilities of communications between persons with similar interests—primarily related to carriage of various objects, while providing a user with the possibility of operatively changing his interests in real or future time, and, thus, improve the method performance when exchanging such data.

In order to find a solution to the set task and achieve the stated technical effect, the first embodiment of the method for data interchange in a computer network consists in that data on computing devices users connected to the Internet is registered at a remote server via the Internet, indicating data on user locations, data on the possibility of carriage, status and type of a vehicle, and data on means for communicating to them, said data are inputted into the server database, assigning identification numbers to the computing device users; if a computing device user sends to the remote server a request for carrying and moving an object from a certain departure point to a certain destination point, indicating the locations of said points, then the remote server sends to this competing device a request for limiting the object position range and dimensions of such limitation in order to fulfill requirements to a potential carrier, as well as data on a time period for performing carriage; after the computing device user indicates limitation of the object position range and its dimensions, a time period for performing carriage and sends this data via the Internet to the remote server, the latter selects data on locations of computing device users, who perform carriage and are within the object position range limitation as indicated by the computing device user, i.e., within its dimensions, on a status and type of a vehicle, on means for communicating to said users by identification numbers from its database, and the remote server transmits via the Internet a first of locations of computing device users performing carriage and being within the object position range limitation, the status and type of a vehicle and data on means for communicating to computing device users performing carriage to the computing device of the user who has sent the carriage request.

Additional embodiments of the method according to the first variant are possible, wherein it is possible that:

data on object carriage and transfer from the set departure point to the set destination point, locations of said points being indicated, which data is sent by a competing device user, is transmitted via the Internet from the remote server to computing device users performing carriage and being within the object position range limitation as stated in the request, data on a time period for performing carriage, on means for communicating to the computing device user, who has sent said carriage request to the remote server, being sent to competing devices users performing carriage;

after the computing device user has made a carriage request, the remote server sends via the Internet to that computing device an image of an electronic digital map on which the user puts markers for the departure point and the destination point, the object position range limitation and the range dimensions as well as indicates data on a time period for performing carriage;

the image of the electronic digital map with said indications of the computing device user, who has made the carriage request, is sent by the remote server via the Internet to computing device users performing carriage;

the remote server accumulates in its database data on carriage requests from several computing device users for transferring objects from their departure points to their destination points with indications of locations of said points, and this data is sent as a list via the Internet to computing device users performing carriage and being within object position range limitations; and data on time periods for performing carriage, means for communicating to computing device users, who have sent said carriage requests to the remote server, being also sent to the computing device users performing carriage;

dimensions of said object position range limitation are regulated by the competing device user who has sent the carriage request;

the departure point is located within the object position range limitation, dimensions of this range being limited to a circle with the center coinciding with the departure point location;

the departure point is directly in the indicated location of the computing device user who has sent the carriage request;

the locations of the departure point and the destination point coincide with each other, and the computing device user indicates the location at least of one intermediate destination point in his carriage request.

In order to find a solution to the set task and achieve the stated technical effect, another embodiment of the method for data interchange in a computer network consists in that a remote server via the Internet records data on computing device users connected to the Internet, indicating data on user locations, data on the possibility of performing carriage and data on means for communicating to said computing device users, and it records, in respect of computing device users needing carriage, data on the type of an object to be carried, stores this data in its memory, assigning identification numbers to said computing device users; in a case where a computing device user performing carriage sends via the Internet a request for transportation to the remote server, indicating transfer of a vehicle from the set departure point to the set destination point and stating their locations, then the remote server sends via the Internet to this computing device a request for limiting the object position range and dimensions of this range (limitation area), as well as on a time period for performing carriage (time period for providing a vehicle in the departure point); after the computing device user, who performs carriage, indicates limitation of the object position range and its dimensions, a time period for performing carriage and sends this data via the Internet to the remote server, the latter selects, on the basis of identification numbers, data on locations of objects of computing device users, who need carriage and are within the indicated object position range limitation, i.e., within its dimensions, on the type of the object, on means for communicating to computing device users, from its database, and the remote server transmits via the Internet a list of object positions of computing device users needing carriage and being within the object position range limitation to the computing device user performing carriage, data on the object type and data on means for communicating with computing device users needing carriage.

Additional embodiments of the method according to the second variant are possible, wherein it is possible that:

data of a request for transportation performing by a computing device user and movement of a vehicle from the set departure point to the set destination point, locations of said points being indicated, is transmitted via the Internet from the remote server to computing device users needing carriage and being within the object position range limitation as stated in the request, data on a time period for performing carriage, on means for communicating to the computing device user, who has sent said request for transportation to the remote server, being sent to computing devices users needing carriage;

after the computing device user has made a request for transportation, the remote server sends via the Internet to that computing device an image of an electronic digital map on which the user puts markers for the departure point and the destination point, the object position range limitation and the range dimensions as well as indicates data on a time period for performing carriage;

the image of the electronic digital map with said indications of the computing device user, who has made the request for transportation, is sent by the remote server via the Internet to computing device users needing carriage of objects;

the remote server accumulates in its database information on requests for transportation from several computing device users for moving a vehicle from the set departure point to the set destination point with indications of locations of said points, and this data is sent as a list via the Internet to computing device users needing carriage and being within object position range limitations; and data on time periods for performing carriage, means for communicating to computing device users, who have sent said requests for transportation to the remote server, being also sent to the computing device users needing carriage;

dimensions of said object position range limitation are regulated by the computing device user who has sent the request for transportation;

the departure point is located within the object position range limitation, dimensions of this range being limited to a circle with the center coinciding with the location from where a vehicle starts moving;

the departure point is directly in the indicated location of the computing device user who has sent the request for transportation;

the locations of the departure point and the destination point coincide with each other, and the computing device user indicates the location at least of one intermediate destination point in his request for transportation;

for carriage of objects going same way the computing device user performing carriage further indicates object position range limitation between the departure point and the destination point; and

for carriage of objects going same way the computing device user performing carriage further indicates object position range limitation in the departure point, and the computing device user needing carriage further indicates object position range limitation in the destination point, and when the limitation in the departure points within the object position range of the computing device user performing the carriage crosses the object position range limitation of the computing device user needing carriage as well as when the limitation in the destination points within the object position range of the computing device user performing the carriage crosses the object position range limitation of the computing device user needing carriage, the two objects are carried from their departure points to their destination points.

The above advantages as well as the specific features of this invention are explained below on the basis of its best embodiments with reference to the accompanying drawings.

### BRIEF DESCRIPTION OF THE DRAWINGS

FIG. 1 shows a typical functional diagram of intercommunication between computing devices and a remote server via the Internet.

FIG. 2 shows a possible view of a log-in dialogue box on the computing device display of a user needing carriage.

FIG. 3 shows a possible view of a log-in dialogue box on the computing device display of a user performing carriage or transport of an object.

FIG. 4 shows a possible view of a dialogue box on the computing device display of a user needing carriage for indicating markers of the departure point and the destination point, the object position range limitation and dimensions of the range for the purpose of fulfilling conditions for a potential carrier.

FIG. 5 shows a general block-diagram of the algorithm of the remote server functioning for computing device users needing carriage.

FIG. 6 shows a possible view of a dialogue box on the computing device display of a user needing carriage according to the first embodiment of the invention.

FIG. 7 shows a general block-diagram of the algorithm of the remote server functioning for computing device users performing carriage.

FIG. 8 shows a possible view of a dialogue box on the computing device display of a user performing carriage according to the second embodiment of the invention.

FIG. 9 is an illustration of the carriage principle for computing device users with corresponding routes.

### DESCRIPTION OF THE BEST EMBODIMENTS OF THE INVENTION

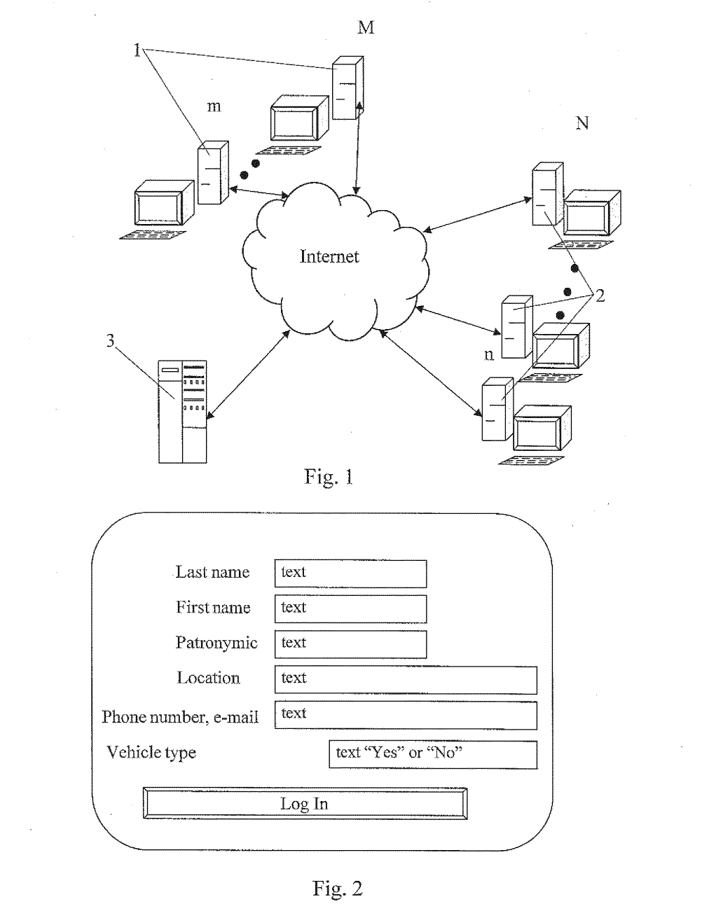

The computing devices 1 and 2 in this invention are understood as computing devices capable of connecting to a remote server 3 via the Internet (FIG. 1). They may be autonomous devices, such as a desktop computer or a notebook, or these may be communications devices, such as a cellular phone, an electronic organizer, a transponder, a portable radio station or another mobile device that may communicate (exchange data) via a network.

The remote server 3 stores in its database information on computing device users 1 in number from m to M, who need carriage, and information on computing device users 2 in number from n to N, who are potential carriers. The total number of computing devices may permanently change as new users log in. Computing devices 1, 2 and the remote server 3 are connected via two-way communications to the Internet. Two-way communications may represent any convenient method for accessing the Internet, e.g., Dial-Up, coaxial cable, fiber optics, Wi-Fi, satellite, and cellular phones.

The first client application of the computing device 1 and the second client application of the computing device 2 communicate with the web application of the remote server 3 by means of link protocol, respectively, which interacts with the database control system via any possible data access interface. The http protocol may serve as the link protocols for the computing devices 1 and 2. A data access interface depends on a programming language used for writing the web application. It will be JDBC (Java DataBase Connectivity—for connecting to databases in Java) for Java-applications, PDO (database access interface) for PHP (PHP: Hypertext Preprocessor).

Any database management system (DBMS) may be used for carrying out of the claimed method, for example MySQL, Oracle or PostgreSQL.

Objects for carriage of transport in this invention are understood as various material objects, e.g., people, things and even, for example, animals.

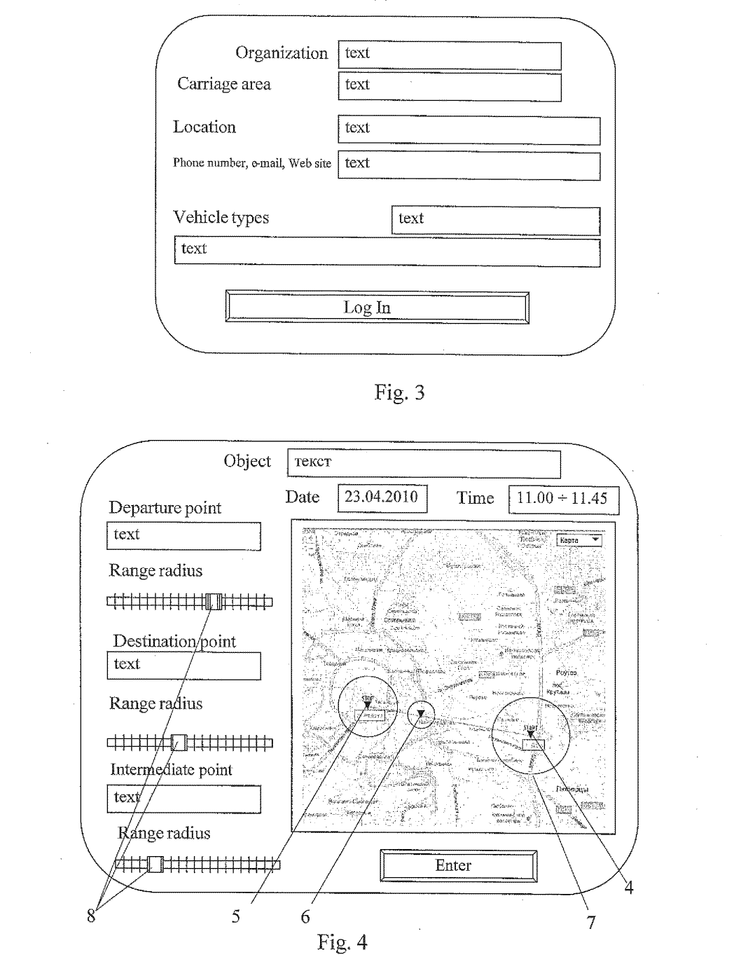

In order to realize the claimed method in practice, a user must log in to the web application of the remote server 3. Computing device users may log in by means of dialogue boxes (FIGS. 2, 3) that may have various forms. The computing devices users 1 and 2 are subdivided in the database of the remote server 3 into users needing carriage, for example when indication “No” in the “Vehicle Type” section of the dialogue box (FIG. 2), or those performing carriage (transport) of objects (FIG. 3). FIG. 3 shows an illustrative box for logging in an organization providing transport. The same type of box may be also used for logging in physical persons as carriers, i.e., performing carriage of objects. The company name should be indicated in the “Organization” status section. The range of carriage, i.e., over a district, city, city and suburbs, intercity, international, etc., should be indicated in the “Carriage Range” section.

After pressing the “Enter” key or pointing the mouse cursor over “Log In” button and clicking (FIGS. 1, 2) data on the computing devices users 1 and 2 are sent to the remote server 3 via the Internet.

Data on locations of the computing devices users 1 and 2 are presented as geopoints (geographic coordinates, i.e., latitude and longitude) and are stored in the database of the remote server 1.

When a the computing device user 1 requests carriage by means of a dialogue box (not shown in Figures since it may have various forms) which is used by him for sending to the remote server 3 a request for carriage and movement of an object from the set departure point to the set destination point the locations of these points being indicated, the system starts functioning. For the purpose of convenient and quick data processing the dialogue box for a carriage request may also contain additional information, such as country, locality and address. The web application of the remote server 1 searches for a matched country, locality and address and define the corresponding geographic coordinates of the geopoints of the departure and destination points.

For the purpose of convenient dialogue with the computing device user 1 it is advisable to use an electronic digital map. If the coordinates of the geopoints are known from the database of the remote server 3, then after receiving a carriage request an image of the corresponding electronic digital map is sent to the computing device user 1 from the remote server via the Internet (FIG. 4).

The user puts the marker 4 for the departure point and the marker 5 for the destination point, the object position range limitation and the dimensions of this range (limitation area) on the map and indicates data on a time period for performing carriage (shipping of the object). Furthermore, the following may be indicated additionally: the object—a passenger or cargo, date (by default it is accepted as existing in this day), the name of the object to be carried, the object dimensions, the direction (one-way, two-way, directions along a circle, along a broken line, etc. may be created for a route comprising more than two geopoints), periodicity of following the route (without repetition, every day, every week, every month, every year).

In addition, the marker 6 may indicate an intermediate destination point where a cargo my be collected or another passenger may be got on the vehicle.

The limitation 7 of the object position range may be controlled by the computing device user 1 who has sent the carriage request.

The marker 4 (departure point) is usually put within the limitation 7 of the object position range, and the dimensions of this range may be limited by a circle with the center coinciding with the location of the object departure point (in a case where the departure point is not a residence address, e.g., when it is necessary to transport goods from a shop or take a passenger to an address). Also, the departure point may be directly in the indicated location (residence address) of the computing device user 1 who has sent the carriage request. In special cases, for example when a locality is extended in one direction, the limitation 7 may be made as an ellipse, square, polygon or other geometric figures.

Furthermore, the locations of the departure point and the destination point may coincide, and the computing device user 1 indicates in his request by the marker 6 a location at least one intermediate destination point where, for example, another passenger may be taken.

By default, each geopoint is assigned a certain range, tor example 3 kilometers. The radius of the object position range limitation 7 may be changed for each geopoint along the route. For this it is necessary to click on the icon of the geopoint and change the geopoint range by means of the scroll bars 8 (scroll boxes) (FIG. 4).

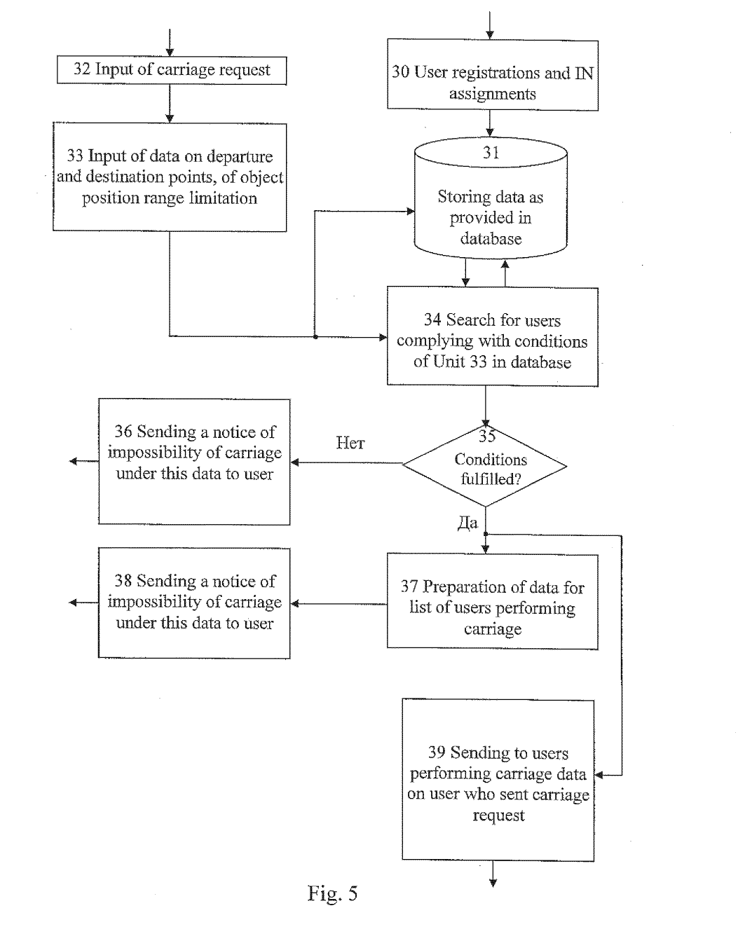

After the computing device user 1 puts the markers 4, 5 of the object position range limitation 7 and its dimensions, indicates a time period for performing carriage and sends this data to the remote server 3 via the Internet, the remote server 3 works as follows (FIG. 5).

As was said earlier, input, registration of the computing devices users 1, 2 and assignment of unique identification numbers (IN) to them are performed in the unit 30. Data on the computing devices users 1, 2 is stored in the database 31. The name, the location (geopoint coordinates), the means for communication are stored for the computing devices users 1. And the computing device user 1 may apply to the remote server 3 for the first time and immediately after logging in make his request for carriage. The name, the location (geopoint coordinates), the mode of carriage (daily, around-the-clock, one time), the carriage area, the vehicle type, the means for communicating to them are stored for the computing devices users 2.

After entering a carriage request into the unit 32 and subsequent entering data on the points of departure and destination (their geopoint coordinates), a time period, the object position range limitation 7 with its radius K into the unit 33, the unit 34 performs a search in the database of users matching the conditions of the unit 33. If the database 31 does not have any data on routes where the circle radii of the geopoint range limitation 7 do not cross data of the carriage areas of the computing devices user 2, and such routes do not coincide in time, the comparison unit 35 provides output information “No” that enters into the unit 36 for the purpose of sending a message on the impossibility of carriage according to the data indicated in the request to the computing device user 1. Then the user may either expand the dimensions of the object position range limitation 7, or change the time period for shipping, or repeat this carriage request.

If data on such routes is present in the database 31, which circle radii of the object position range limitations 7 from the existing geopoints 5 cross (the geopoint of the computing device user 2 is within the limitation 7) and which correspond to the time period, then the comparison unit 35 provides output information “Yes”. This information enters the unit 37 for the purpose of preparing a list of the computing device users 2 performing carriage (transport). Then, the unit 38 sends data on the list of the computing device users 2 performing carriage to the computing device user 1. In a case where within the limitation 7 there is only one organization or physical person performing carriage (transport), the list may comprise only one column.

Thus, the computing device user 1 is informed about the carriers closer to the object point of departure, which reduces the delivery time and, accordingly, the carriage cost.

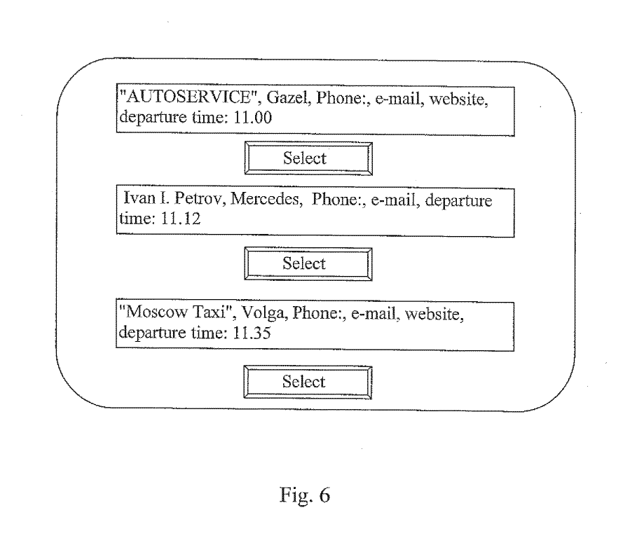

The data of the list of the users performing carriage (transport) is sent to the computing device user 1 in the form, for example, of the dialogue box (FIG. 6) that may comprise, in addition to the vehicle type and the departure time, other additional data, such as: the vehicle production year, the driver characteristics (driving record, category) etc. After the computing device user 1 selects one nominee from the list and clicks on the respective “Select” button, direct communication between the computing device user 1 and the computing device user 2 becomes possible by means of e-mail messages or their web sites, or the former may call the latter, using usual a stationary or cellular phone.

Furthermore, the data of the carriage request sent by the computing device user 1 for transferring an object from a set departures point to a set destination point with the indication of their locations via the Internet may be sent by the unit 39 of the remote server 3 (FIG. 5) to the computing device users 2 performing carriage, which geopoints are within the object position range limitation 7 stated in the request for transportation. The data, as sent to the computing device users 2, include data on the departure point and the destination point, on the time period for performing carriage, on the means for communicating to the composing device user 1.

The set task for the computing device users 2 performing carriage of cargo or passengers is solved in the same way. For this variant the remote server 3 works as follows (FIG. 6).

The unit 30 performs input and registration of the computing device users 1, 2 and assigns INs to them. Data on the computing device users 1, 2 are stored in the database 31.

The carriage request from the computing device user 1 is inputted into the unit 40, and then data on the departure and destination points (their geopoint coordinates), the time period and, in addition, data on the type of an object for carriage (passengers or cargo) is inputted into the unit 41; the object position range limitation 7 with its radius K may or may not be inputted, as will be explained below with reference to FIG. 9.

The request for transportation from the computing device user 2 is inputted into the unit 42, and then data on movement of the vehicle from the set departure point to the set destination point, the point locations being indicated, the carried object position range limitation and the dimensions of the range, data on the object type and the carriage period of time is inputted into the unit 43.

The data of the carriage request and the request for transportation are inputted into the database 31 of the remote server 3 in the future (delayed) time mode or in the real time mode into the unit 44 (but this data are still inputted into the database 31 of the remote server 3).

The unit 44 conducts a search for users complying with the conditions of the units 41 and 43. If the geopoint from the request for transportation is outside the database 31 on routes, where, for example, it is outside the circle radius of the object position range limitation 7 (action of the geopoint) of the vehicle departure point for the computing device user 2, or if the request data does not comply with the time periods, then the comparison unit 45 provides output information “No” which enters the unit 46 for the purpose of sending a notice to the confuting device user 2 on the impossibility of carriage under the data stated in the request. The computing device user 2 may expand the dimensions of the object position range limitation 7 or change the departure time period and repeat his request for transportation.

If the database 31 contains data on routes where the object position range limitation 7 (circle radius) for the vehicle point of departure includes the geopoints of the locations stated in the carriage requests front computing device users 1, and if this data compiles with the time period then the comparison unit 45 provides output information “Yes”. This information enters the unit 47 for the purpose of preparing a list of users needing carriage. Then, the unit 48 sends to the computing device user 2 data on the list of computing device users 1 needing carriage. In a case where within the limitation 7 there is only one user performing carriage, the list may comprise only one column.

Thus, the computing device users 2 are informed about the users needing carriage who are closest to the vehicle departure point.

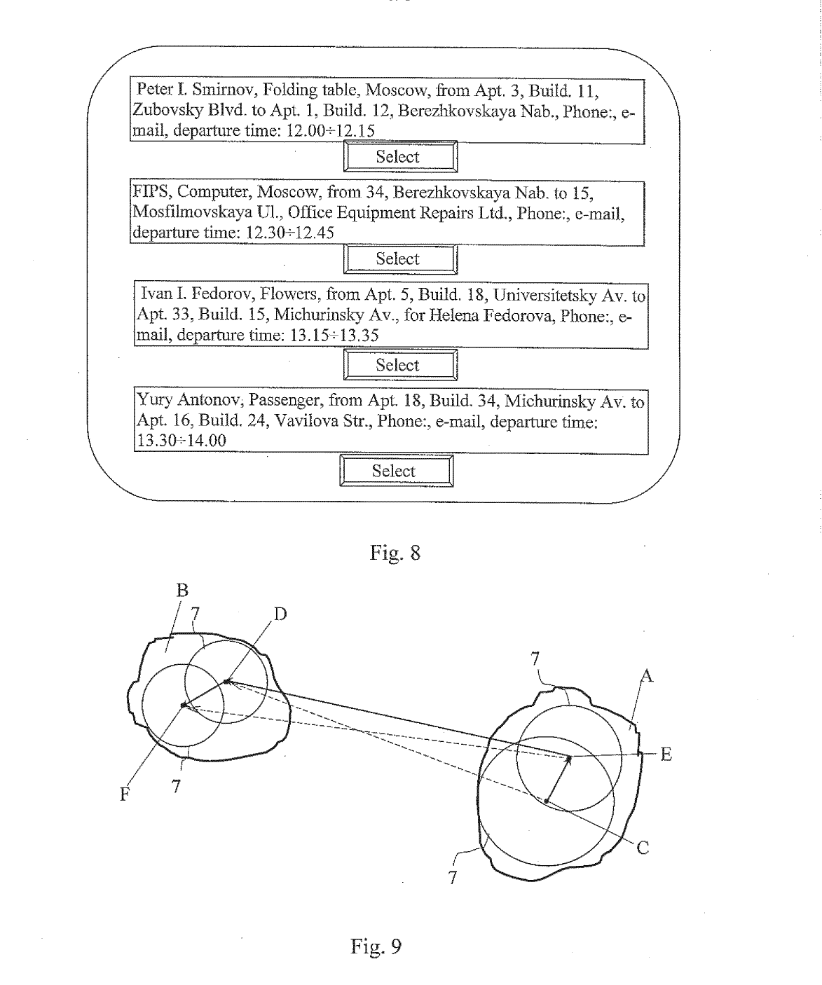

The data of the list of the users needing carriage is sent to the computing device user 2 in the form, for example, of the dialogue box (FIG. 8) that comprises the object type and the time of departure from the carriage client location. Other additional data may be indicated, such as: cargo weight, cargo dimensions, number of passengers, etc.

After the computing device user 2 (FIG. 8) selects one nominee from the list and clicks on the respective “Select” button, direct communication between the computing device user 2 and the computing device user 1 becomes possible by means of e-mail messages, or the former may call the latter, using usual a stationary or cellular phone.

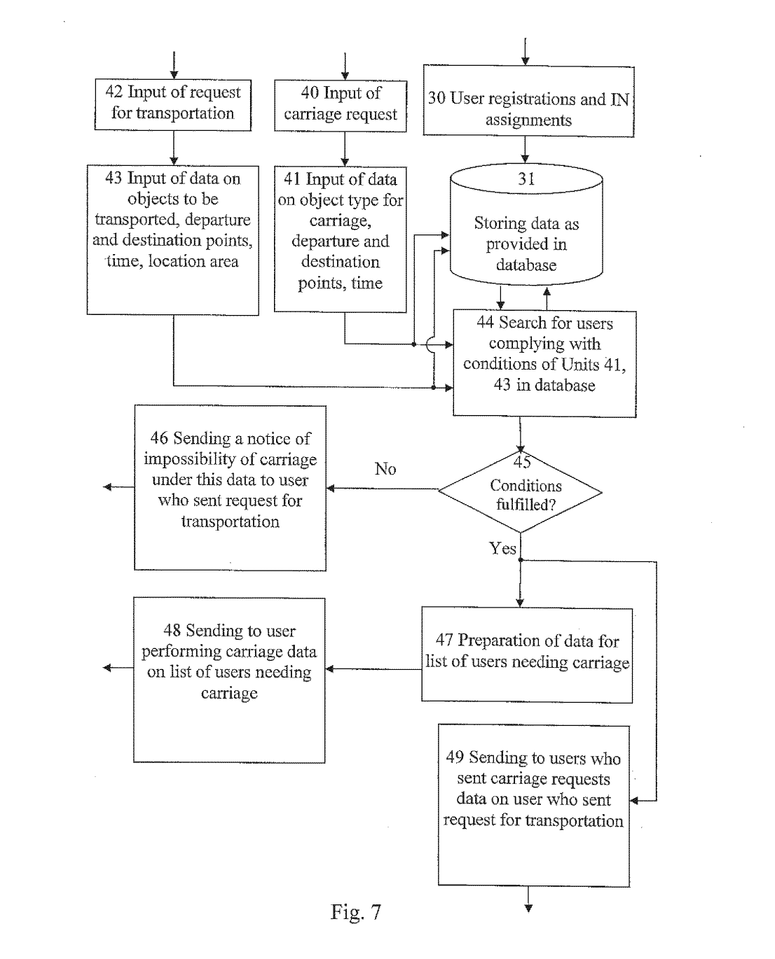

Furthermore, the data of the request for transportation from the comparing device user 2 and data on movement of the object from the departure point to the destination point, the locations of the points being indicated, may be also sent by the unit 49 (FIG. 7) of the remote server 3 via the Internet to computing device users 1 needing carnage. The latter are informed about the point of departure and the point of destination, the time of arrival of the vehicle to the object position, means for communicating to the computing device user 2.

It is advisable that the computing device users 2 performing carriage, when they determine departure points and destination points most distant from each other, also use the marker 6 for indicating an intermediate destination point (FIG. 4) or several such points. As a result, the computing device user may create an optimized route that enables to move various passengers and objects (FIG. 8).

Furthermore, it is advisable to indicate, when sending a carriage request, data on the object position range limitation for the departure and destination points in the unit 41 (FIG. 7), and both the object position range limitation for the departure point and the object position range limitation for the destination point in the unit 43 (FIG. 4). In such a case two or more passengers or two or more goods may be carried by one vehicle, for example, from possible two vehicles on the same route (FIG. 9).

Suppose that it is necessary to perform carriage from the city A to the city B. One object from the departure point C in the city A is destined for delivery to the destination point D in the city B, and another object from the departure point E in the city A is destined for delivery to the destination point F in the city B (shown by a dashed line). If the object position range limitations 7 cross each other in the city A and in the city B, and the departure time in the city A is within necessary time periods, then one-time delivery of both objects is possible, for example, along the route C-E-D-F (shown by arrows in 9). Simultaneous delivery of several objects is also possible, for example, with another additional limitation 7, crossing limitations of any ranges and coinciding corresponding time periods (not shown in FIG. 9 for the sake of clarity).

Those skilled in the art will understand that the above illustrative embodiments of the claimed method for data interchange in a computer network in respect of road transport may be also applicable in respect of other types of transport, namely, railway, river, air transport.

Thus, for example, if a computing device user 1 indicates a railway station as the departure point, a destination point and a departure time, a computing device 2 may inform the user 1 about train timetable for the time period indicated, a train type, its comfort, a car type, ticket availability or impossibility of traveling. If delivery to a destination point is possible from several railway stations, then the user may obtain comparative characteristics of travel time and travel comfort for different carriers. Exactly so, in cases of air transport and indication of several airports requesters of flights may receive data on dates and flight timetable, airplane types, ticket availability, possibility of being delivered to a destination point by plane, helicopter, etc. And computing device users 2 may collect all necessary information on users needing their services.

### INDUSTRIAL APPLICABILITY

The claimed method for data interchange in a computer network (variants) may be most successfully applied for the purpose of providing necessary information on possible variants of travel, providing transportation services of various kinds, optimizing movement of objects in real and future time to computing device users—consumers, both needing carriage and providing services for carrying various objects.

While the foregoing is directed to embodiments of the present invention, other and further embodiments of the invention can be devised by those of ordinary skill in the art based on this description without departing from the basic scope thereof, and the scope thereof is determined by the claims that follow.

What is claimed is:

1. A method for data interchange in a computer network consisting in that data on computing devices users connected to the Internet is registered at a remote server via the Internet, indicating data on user locations, data on the possibility of carriage, status and type of a vehicle, and data on means for communicating to them, said data are inputted into the server database, assigning identification numbers to the computing device users; if a computing device user sends to the remote server a request for carrying and moving an object from a certain departure point to a certain destination point, indicating the locations of said points, then the remote server sends to this computing device a request for limiting the object position range and dimensions of such limitation in order to fulfill requirements to a potential carrier, as well as data on a time period for performing carriage; after the computing device user indicates limitation of the object position range and its dimensions, a time period for performing carriage and sends this data via the Internet to the remote server, the latter selects data on locations of computing device users, who perform carriage and are within the object position range limitation as indicated by the computing device user, i.e., within its dimensions, on a status and type of a vehicle, on means for communicating to said users by identification numbers from its database, and the remote server transmits via the Internet a list of locations of computing device users performing carriage and being within the object position range limitation, the status and type of a vehicle and data on means for communicating to computing device users performing carriage to the computing device of the user who has sent the carriage request.

2. A method according to claim 1, characterized in that data of a carriage request and movement of an object from a set departure point to a set destination point, locations of said points being indicated, which data is sent by a computing device user, is transmitted via the Internet from a remote server to computing device users performing carnage and being within an object position range limitation as stated in the request, data on a time period for performing carriage, on means for communicating to the computing device user, who has sent said carriage request to the remote server, being sent to computing devices users performing carriage.

3. A method according to claim 1, characterized in that after the competing device user has made a carriage request, the remote server sends via the Internet to that computing device an image of an electronic digital map on which the user puts markers for the departure point and the destination point, the object position range limitation and the range dimensions as well as indicates data on a time period for performing carriage.

4. A method according to claim 3, characterized in that said image of said electronic digital map with said indications of the computing device user, who has made the carriage request, is sent by the remote server via the Internet to computing device users performing carriage.

5. A method according to claim 1, characterized in that the remote server accumulates in its database data on carriage requests from several computing device users for transferring objects from their departure points to their destination points with indications of locations of said points, and this data is sent as a list via the Internet to computing device users performing carriage and being within object position range limitations; and data on time periods for performing carriage, means for communicating to computing device users, who have sent said carriage requests to the remote server, being also sent to the computing device users performing carriage.

6. A method according to claim 1, characterized in that dimensions of said object position range limitation are regulated by the computing device user who has sent the carriage request.

7. A method according to claim 1, characterized in that the departure point is located within the object position range limitation, dimensions of this range being limited to a circle with the center coinciding with the departure point location.

8. A method according to claim 1, characterized in that the departure point is directly in the indicated location of the computing device user who has sent the carriage request.

9. A method according to claim 1, characterized to that the locations of the departure point and the destination point coincide with each other, and the computing device user indicates the location at least of one intermediate destination point in his carriage request.

10. A method for data interchange in a computer network, consisting in that a remote server via the Internet records data on competing device users connected to the Internet, indicating data on user locations, data on the possibility of performing carriage and data on means for communicating to said computing device users, and it records, in respect of computing device users needing carriage, data on the type of an object to be carried, stores this data in its memory, assigning identification numbers to said computing device users; in a case where a computing device user performing carriage sends via the Internet a request for transportation to the remote server, indicating transfer of a vehicle from the set departure point to the set destination point and stating their locations, then the remote server sends via the Internet to this computing device a request for limiting the object position range and dimensions of this range (limitation area), as well as on a time period for performing carriage (time period for providing a vehicle in the departure point); after the computing device user, who performs carriage, indicates limitation of the object position range and its dimensions, a time period for performing carriage and sends this data via the Internet to the remote server, the latter selects, on the basis of identification numbers, data on locations of objects of computing device users, who need carriage and are within the indicated object position range limitation, i.e., within its dimensions, on the type of the object, on means for communicating to computing device users, from its database, and the remote server transmits via the Internet a list of object positions of computing device users needing carriage and being within the object position range limitation to the computing device user performing carriage, data on the object type and data on means for communicating with computing device users needing carriage.

11. A method according to claim 10, characterized in that data of a request for transportation performing by a computing device user and movement, of a vehicle from the set departure point to the set destination point, locations of said points being indicated, is transmitted via the Internet from the remote server to computing device users needing carriage and being within the object position range limitation as stated in the request, data on a time period for performing carriage, on means for communicating to the computing device user, who has sent said request for transportation to the remote server, being sent to computing devices users needing carriage.

12. A method according to claim 10, characterized in that after the computing device user has made a request for transportation, the remote server sends via the Internet to that computing device an image of an electronic digital map on which the user puts markers for the departure point and the destination point, the object position range limitation and the range dimensions as well as indicates data on a time period for performing carriage.

13. A method according to claim 12, characterized in that an image of the electronic digital map with said indications of the computing device user, who has made the request for transportation, is sent by the remote server via the Internet to computing device users needing carriage of objects.

14. A method according to claim 10, characterized in that the remote server accumulates in its database information on requests for transportation from several computing device users for moving a vehicle from the set departure point to the set destination point with indications of locations of said points, and this data is sent as a list via the Internet to computing device users needing carriage and being within object position range limitations; and data on time periods for performing carriage, means for communicating to computing device users, who have sent said requests for transportation to the remote server, being also sent to the computing device users needing carriage.

15. A method according to claim 10, characterized in that dimensions of said object position range limitation are regulated by the computing device user who has sent the request for transportation.

16. A method according to claim 10, characterized in that the departure point is located within the object position range limitation, dimensions of this range being limited to a circle with the center coinciding with the location from where a vehicle starts moving.

17. A method according to claim 10, characterized in that the departure point is directly in the indicated location of the computing devise user who has sent the request for transportation.

18. A method according to claim 10, characterized in that the locations of the departure point and the destination point coincide with each other, and the computing device user indicates the location at least of one intermediate destination point in his request for transportation.

19. A method according to claim 10, characterized in that for carriage of objects going same way the computing device user performing carriage further indicates object position range limitation between the departure point and the destination point.

20. A method according to claim 10, characterized in that for carriage of objects going same way the computing device user performing carriage further indicates object position range limitation in the departure point, and the computing devise user needing carriage further indicates object position image limitation in the destination point, and when the limitation in the departure points within the object position range of the computing device user performing the carriage crosses the object position range limitation of the competing device user needing carriage as well as when the limitation in the destination points within the object position range of the computing device user performing the carriage crosses the object position range limitation of the computing device user needing carriage, the two objects are carried from their departure points to their destination points.
